(19) United States
(12) Patent Application Publication
(10) Pub. No.: US 2008/0320192 A1
(43) Pub. Date: Dec. 25, 2008

(54) FRONT SIDE BUS PERFORMANCE USING AN EARLY DEFER-REPLY MECHANISM

(76) Inventors: Sundaram CHINTHAMANI, Hillsboro, OR (US); Sivakumar RADHAKRISHNAN, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/764,936

(22) Filed: Jun. 19, 2007

(51) Int. Cl. G06F 13/362

(52) U.S. Cl. 710/113

(57) ABSTRACT

Embodiments of the invention are generally directed to systems, methods, and apparatuses for improving the performance of a front side bus using an early defer-reply mechanism. In some embodiments, an integrated circuit receives a memory read request and accesses memory to obtain read data responsive to receiving the memory read request. The integrated circuit may initiate a defer-reply transaction corresponding to the memory read request N front side bus (FSB) clocks prior to receiving the read data from the memory.

### TECHNICAL FIELD

Embodiments of the invention generally relate to the field of integrated circuits and, more particularly, to systems, methods and apparatuses for improving the performance of a front side bus using an early defer-reply mechanism.

### BACKGROUND

A front side bus (or system bus) refers to a bi-directional bus that carries information between one or more processors and the rest of the computing system (e.g., the chipset). A memory read transaction refers to a transaction to access data (e.g., read data) from system memory. A read transaction may have a number of elements including the transfer of a request from a processor to the chipset over the front side bus and the transfer of the read data to the requester from the chipset via the front side bus.

A typical memory read transaction can be completed in one of two modes: the in order mode and the defer-reply mode. When operating in the in order mode, transactions are completed in the order of arrival (e.g., FIFO). A current transaction is completed before a subsequent transaction is processed.

When operating in the defer-reply mode, a memory transaction is initially deferred by the chipset using a split transaction protocol. After the chipset receives the read data from memory (or another source), the chipset arbitrates for control of the front side bus. The read data is transferred to the requester after the chipset gains control of the front side bus. The term “defer-reply transaction” refers to the portion of the split transaction when the chipset arbitrates for control of the bus and returns the read data to the requester.

A disadvantage of the conventional defer-reply mechanism is that it can increase the idle latency of the deferred read transaction. The increase is due, in part, to the additional time that it takes for a defer-reply transaction to go through all of the front side bus protocol phases (e.g., arbitration, snoop, and response).

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a high-level block diagram illustrating selected aspects of a computing system implemented according to an embodiment of the invention.

FIG. 2 is a block diagram illustrating selected aspects of a computing system having an early defer-reply mechanism according to an embodiment of the invention.

FIG. 3 is a timing diagram illustrating selected aspects of chipset arbitration overhead for a computing system according to an embodiment of the invention.

FIG. 4 is a flow diagram illustrating selected aspects of a method for improving the performance of a front side bus using an early defer-reply mechanism according to an embodiment of the invention.

### DETAILED DESCRIPTION

Embodiments of the invention are generally directed to systems, methods, and apparatuses for improving the performance of a front side bus using an early defer-reply mechanism. In some embodiments, the defer-reply transaction is initiated N front side bus (FSB) clocks before the read data arrives from memory. As is further described below, the idle latency may be reduced because the defer-reply transaction is at last partly overlapped with the time that it takes for data to arrive from memory.

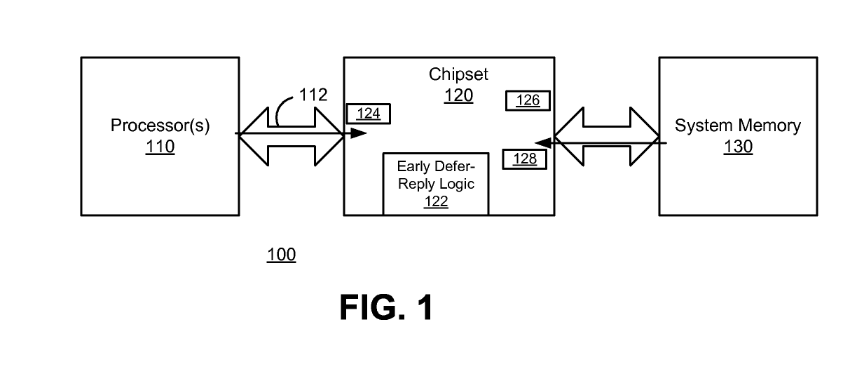

FIG. 1 is a high-level block diagram illustrating selected aspects of a computing system implemented according to an embodiment of the invention. System 100 includes processor 110, chipset 120, and system memory 130. Processor 110 may be any of a wide range of processing elements including a general-purpose processor, a graphics processor, an application specific integrated circuit (ASIC), and the like. While FIG. 1 shows a single processor it is to be appreciated that embodiments of the invention may include two or more processors. In addition, processor 110 may have a single processor core or may include multiple processor cores (e.g., 2, 4, 8, . . . 80, etc.).

Chipset 120 connects processor 110 with one or more other elements of system 100 (e.g., with system memory 130). Chipset 120 may include one or more integrated circuits (e.g., a northbridge and a southbridge). In some embodiments, selected aspects of the chipset 120 may be integrated onto processor 110.

System memory 130 provides the main memory for system 100. In some embodiments, system memory 130 may include one or more memory modules each having one or more memory devices. The memory devices may be volatile memory devices (e.g., dynamic random access memory devices or DRAMs), non-volatile memory devices (e.g., flash devices), or a combination of volatile and non-volatile memory devices.

Chipset 120 includes early defer-reply logic 122 (or, for ease of reference, logic 122). In some embodiments, logic 122 enables chipset 120 to reduce the idle latency of a read transaction while operating in the defer-reply mode. Consider, for example, a read transaction that includes a request (124) for read data. After receiving request 124, chipset 120 may use a split transaction to initially defer the associated transaction. The process of obtaining data from system memory 130 may be deterministic and, thus, chipset 120 may know how many clock cycles it will take for the read data to return from system memory 130. For example, register 126 may store a value indicating how many clock cycles it takes for read data to be returned to from system memory 130.

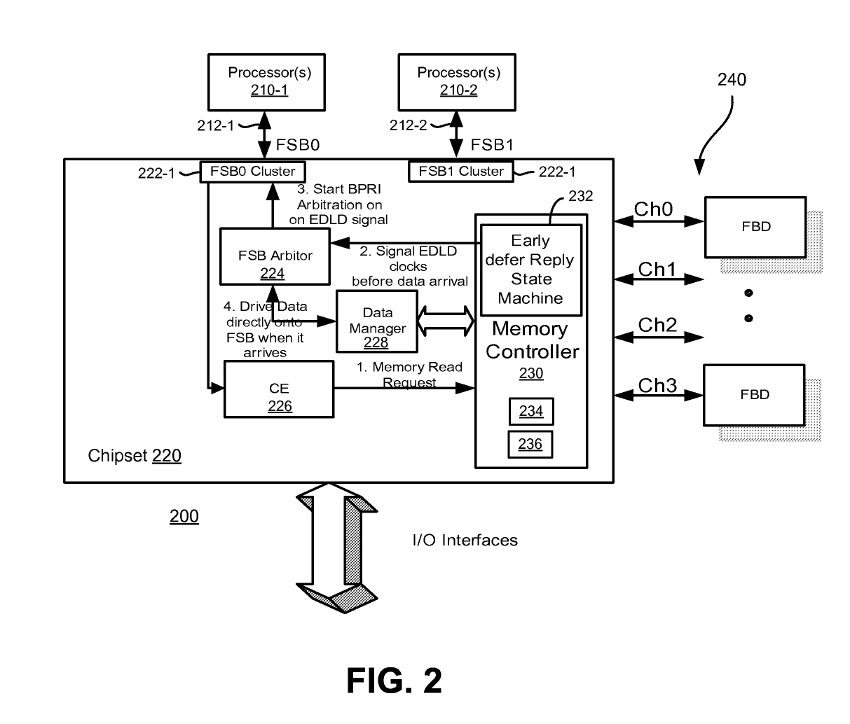

In some embodiments, early defer-reply logic 122 initiates the defer-reply transaction N FSB clocks before it receives read data 128 from system memory 130. The value N may be selected so that chipset 120 has control of front side bus 112 when (or prior to the time that) read data arrives from system memory 130. Thus, in some embodiments, chipset 120 can transfer read data 128 to processor 110 as soon as (or substantially as soon as) it arrives from system memory. Early defer-reply logic 122 is further discussed below with reference to FIGS. 2-4.

FIG. 2 is a block diagram illustrating selected aspects of a computing system having an early defer-reply mechanism according to an embodiment of the invention. System 200 includes processors 210, chipset 220, and system memory 240. Processors 210 may be general purpose processors and may include multiple processor cores.

Front side bus (FSB) 212 couples processors 210 to chipset 220. In some embodiments, FSB 212 is a multi-drop bus that implements a fully pipelined and multiphase bus protocol. In the illustrated embodiment, FSB 212 is configured in a dual-independent-bus (DIB) architecture to provide point-to-point interconnects between the processors 210 and chipset 220. In alternative embodiments, the features of FSB 212 may be different.

System memory 240 includes channels 0-3 each of which may have one or more memory modules. Each memory module may, in turn, include one or more memory devices (e.g., DRAMs). In some embodiments, system memory 240 includes fully-buffered dual inline memory module (FBD) technology. In alternative embodiments, other memory technologies may be used.

Chipset 220 includes FSB clusters 222, arbitration logic 224, coherency engine 226, data manager 228, and memory controller 230. FBS clusters 222 provide logic to interface with FSB 212 (e.g., signals to implement to bus protocol). Arbitration logic 224 provides logic to arbitrate for control of FSB 212. Coherency engine (CE) 226 provides a number of functions including tracking transactions, routing transactions, resolving conflicts, providing coherency, and the like. Data manager 228 provides a local staging buffer to hold as they move from source to destination. Memory controller 230 provides an interface between chipset 220 and system memory 240. In alternative embodiments, chipset 220 may include more elements, fewer elements, and/or different elements. In addition, the functions of chipset 220 may be provided by a single integrated circuit or may be provided by multiple integrated circuits.

In operation, a process (e.g., executing on processor 210-1) may access memory. In response, processor 210-1 may acquire control of FSB 212 and put a memory read transaction on the FSB. Coherency engine 226 receives an indication of the transaction and, if appropriate, launches a memory read request (1) to memory controller 230. Coherency engine 226 may also allocate a buffer in data manager 228 for the transaction (e.g., to hold the read data when it arrives from memory).

Memory controller 230 receives the request and maps the request to the banks, ranks, channels, etc., of system memory 240. To perform the mapping, memory controller 230 may reference a memory map representing the structure of system memory 240. The memory map may be based on information stored in registers 234. Registers 234 may be set during system initiation.

Memory controller 230 obtains read data corresponding to the request from system memory 240. Since memory accesses are deterministic, memory controller 230 knows how long the round trip time to obtain the read data is (e.g., based on a value stored in registers 234). In some embodiments, early defer-reply logic (or, for ease of reference, logic) initiates the defer-reply transaction N FSB clocks before receiving the read data from system memory 240. For example, logic may signal arbitration logic 224 to begin arbitration for the FSB N FSB clocks before receiving the read data (2). In some embodiments, the acronym EDLD (early defer-reply delay) is used to represent a value indicating when (e.g., how many clocks prior to the arrival of data from memory) the defer-reply transaction should be started.

Arbitration logic 224 starts the arbitration process (3) in accordance with the FSB protocol (e.g., by asserting BPRI). Once the read data arrives, memory controller 230 provides the read data to data manager 228. In some embodiments, the read data is directly driven onto FSB 212 when it arrives (4) because arbitration logic 224 has acquired control of FSB 212.

In some embodiments, the value N is programmable. For example, the value N may be programmed into register 236. The value N may be programmed during or after system initiation. This enables a specific value of N to be used for different chipsets. Having a specific value of N for different chipsets is desirable because the latency overhead for the defer-reply transaction varies for different processor and chipset combinations. In addition, since logic 232 is implemented in the memory clock domain, the value N is set in terms of M memory clock cycles. The latency overhead for the defer-reply transaction, however, is in the bus clock domain. For platform configurations with gearing (e.g., where the FSB and the memory controller operate at different frequencies), the programmable option for the value N provides the ability to tune the delay so that the entire latency overhead for the defer-reply transaction can be overlapped with the time it takes for data to arrive from system memory (or another socket).

The core (FSB) clock and the memory clock can have different gearing ratios, depending on the specifics of the chipset, such as 1:1, 4:5, 5:4, etc. In some cases, the gearing ratio is 1:1 and N FSB clocks is the same as M memory clocks (e.g., N may equal M). This is not, however, the case in general. Thus, in some embodiments, the differences in gear ratios are accounted for when setting the EDLD register (e.g., register 236, shown in FIG. 2). For example, if the goal is to achieve N FSB clocks of overlap, then the equivalent timing (in M memory clocks) is calculated based on the ratios of a particular chipset and FSB combination.

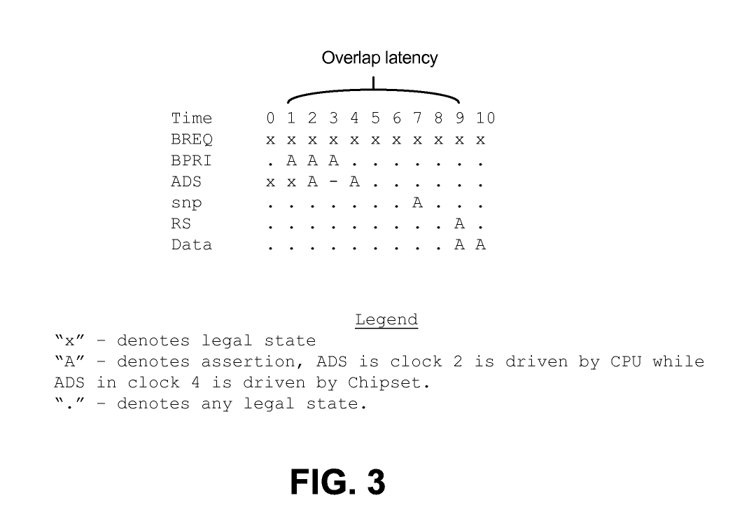

FIG. 3 is a timing diagram illustrating selected aspects of chipset arbitration overhead for a computing system according to an embodiment of the invention. BPRI is asserted at clock 1. For the platform corresponding to the diagram, the earliest that the read data can be driven is clock 9. Thus, this platform has a latency overhead of 8 bus clocks for the defer-reply transaction. In some embodiments, the value N is selected for a given platform so that the latency overhead for the defer-reply transaction (8 bus cycles in the illustrated case) overlaps with the length of time it takes for the read data to arrive from memory. For example, if the latency overhead is 8 cycles and the round trip latency for the memory controller to receive read data is 20 cycles, then N may set to 12 cycles. It is to be appreciated that an appropriate value for N may be different for different system configurations.

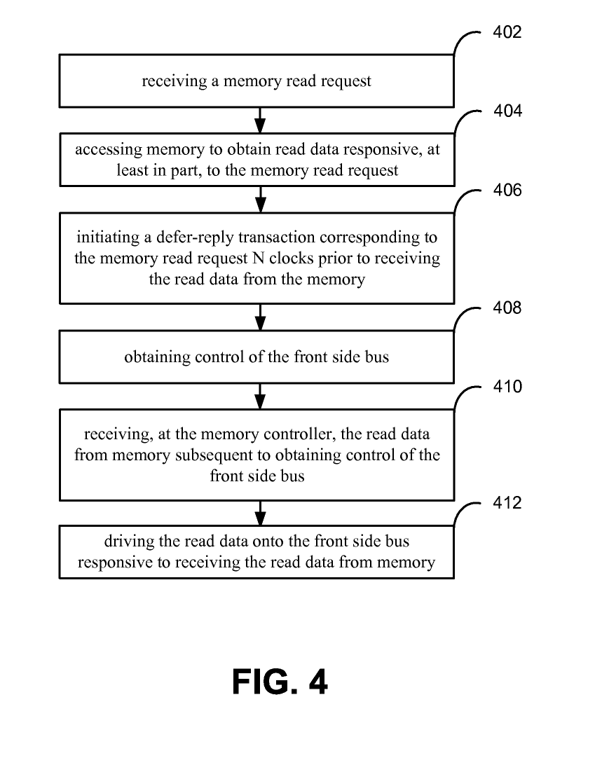

FIG. 4 is a flow diagram illustrating selected aspects of a method for improving the performance of a front side bus using an early defer-reply mechanism according to an embodiment of the invention. Referring to process block 402, a memory controller receives a memory read request. In response, the memory controller accesses system memory to obtain the appropriate read data (404).

In some embodiments, early defer-reply logic initiates a defer-reply transaction corresponding to the read request N FSB clocks prior to receiving the read data from memory (406). In response to an indication from the early defer-reply logic, arbitration logic obtains control of the FSB at 408.

Referring to process block 410, the memory controller receives the read data from the system memory. In some embodiments, the chipset may have control of the FSB when the read data arrives from system memory because the early defer-reply logic started the defer-reply transaction before the data arrived. Thus, in some embodiments, the read data may be directly driven onto the front side bus once it is received from system memory (412).

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. A method comprising:
receiving, at a memory controller, a memory read request;
accessing memory to obtain read data responsive, at least in part, to the memory read request; and
initiating a defer-reply transaction corresponding to the memory read request N front side bus (FSB) clocks prior to receiving the read data from the memory.

2. The method of claim 1, wherein initiating a defer-reply transaction corresponding to the memory read request N FSB clocks prior to receiving the read data from the memory comprises:
signaling arbitration logic to initiate arbitration on a front side bus N FSB clocks prior to receiving the read data from the memory.

3. The method of claim 1, wherein N is a programmable value.

4. The method of claim 3, wherein the programmable value is selected to enable a memory idle latency to be substantially the same for both an in order queue mode and a defer-reply mode.

5. The method of claim 1, further comprising:
obtaining control of the front side bus;
receiving, at the memory controller, the read data from memory subsequent to obtaining control of the front side bus; and
driving the read data onto the front side bus responsive to receiving the read data from memory.

6. The method of claim 5, wherein the front side bus provides a point-to-point interconnect with a processor.

7. The method of claim 6, wherein the processor includes a plurality of processor cores.

8. The method of claim 7, wherein the front side bus implements a bus protocol having a plurality of phases.

9. The method of claim 1, wherein the N FSB clocks are substantially equal to M memory clocks.

10. An integrated circuit comprising:
arbitration logic to couple with a front side bus, the arbitration logic to arbitrate for control of the front side bus; and
a memory controller coupled with the arbitration logic, the memory controller including logic to
receive a memory read request,
access memory to obtain read data responsive, at least in part, to the memory read request; and
initiate a defer-reply transaction corresponding to the memory read request N front side bus (FSB) clocks prior to receiving the read data from the memory.

11. The integrated circuit of claim 10, wherein the logic to initiate the defer-reply transaction corresponding to the memory read request N FSB clocks prior to receiving the read data from the memory comprises logic to
signal the arbitration logic to initiate arbitration on a front side bus N FSB clocks prior to receiving the read data from the memory.

12. The integrated circuit of claim 10, wherein N is a programmable value and the integrated circuit comprises a storage location to store the programmable value.

13. The integrated circuit of claim 12, wherein the programmable value is selected to enable a memory idle latency to be substantially the same for both an in order queue mode and a defer-reply mode.

14. The integrated circuit of claim 13, wherein the memory controller further comprises logic to
obtain control of the front side bus;
receive, at the memory controller, the read data from memory subsequent to obtaining control of the front side bus; and
drive the read data onto the front side bus responsive to receiving the read data from memory.

15. The integrated circuit of claim 14, wherein the front side bus provides a point-to-point interconnect with a processor.

16. The integrated circuit of claim 15, wherein the processor includes a plurality of processor cores.

17. The integrated circuit of claim 16, wherein the front side bus implements a bus protocol having a plurality of phases.

18. The integrated circuit of claim 10, wherein the N FSB clocks are substantially equal to M memory clocks.

19. A system comprising:
a volatile memory device to provide system memory; and
an integrated circuit coupled with the volatile memory device, the integrated circuit having
arbitration logic to couple with a front side bus, the arbitration logic to arbitrate for control of the front side bus; and
a memory controller coupled with the arbitration logic, the memory controller including logic to
receive a memory read request,
access memory to obtain read data responsive, at least in part, to the memory read request; and
initiate a defer-reply transaction corresponding to the memory read request N front side bus (FSB) clocks prior to receiving the read data from the memory.

20. The system of claim 19, wherein the logic to initiate the defer-reply transaction corresponding to the memory read request N FSB clocks prior to receiving the read data from the memory comprises logic to
signal the arbitration logic to initiate arbitration on a front side bus N FSB clocks prior to receiving the read data from the memory.

21. The system of claim 20, wherein N is a programmable value and the integrated circuit comprises a storage location to store the programmable value.

22. The system of claim 21, wherein the programmable value is selected to enable a memory idle latency to be substantially the same for both an in order queue mode and a defer-reply mode.

23. The system of claim 22, wherein the memory controller further comprises logic to
obtain control of the front side bus;
receive, at the memory controller, the read data from memory subsequent to obtaining control of the front side bus; and
drive the read data onto the front side bus responsive to receiving the read data from memory.

24. The system of claim 23, wherein the front side bus provides a point-to-point interconnect with a processor.
